(19) United States
(12) Patent Application Publication
(10) Pub. No.: US 2026/0093104 A1
(43) Pub. Date: Apr. 2, 2026

(54) METHOD AND DEVICE FOR PROVIDING AN OVERVIEW IMAGE IN LIGHT FIELD MICROSCOPY

(71) Applicant: Carl Zeiss Microscopy GmbH, Jena (DE)

(72) Inventors: Thomas Egloff, Weimar (DE); Miriam Gaissmaier, Freising (DE); Stanislav Kalinin, Weimar (DE); Volodymyr Kudryavtsev, Jena (DE)

(73) Assignee: Carl Zeiss Microscopy GmbH, Jena (DE)

(21) Appl. No.: 19/341,737

(22) Filed: Sep. 26, 2025

(30) Foreign Application Priority Data
Sep. 30, 2024 (DE) 10 2024 209 566.4

(51) Int. Cl. G02B 21/36

(52) U.S. Cl. CPC G02B 21/367; G02B 21/361

(57) ABSTRACT

A method provides an overview image of an object in light field microscopy, in which image data of at least one image of a region of the object are acquired by a detection optical unit and a detector and, on the basis of the image data, a number of z planes (Zn) of the region are computationally reconstructed. Z sections (uhF, F, ohF) around and above and below the focal plane (F) are defined in a z direction and a channel is assigned to each of the z sections (Zn) and image data of structures of the object detected in the respective z sections (Zn) are stored assigned to the respective channel. By a controller, control commands by which an output device is activated are generated, the structures being output according to the respectively assigned channels with different, but channel-specific graphical characteristics. A light field microscope carries out the method.

### CROSS-REFERENCE TO RELATED APPLICATIONS

This patent application claims priority to German Patent Application No. DE 102024209 566.4, filed on September 30, 2024, in the German Patent Office, the entire disclosure of which is hereby incorporated by reference herein.

### BACKGROUND OF THE INVENTION

### FIELD OF THE INVENTION

The invention relates to a method for providing an overview image in microscopy, in particular in light field microscopy, according to the preamble of independent embodiment 1.

The microscopy methods referred to as light field microscopy allow just one or a few image recordings to be used as a basis for making statements about the three-dimensional structure of an object to be imaged (from now on also: specimen). For this purpose, a detection radiation of the specimen picked up in a detection beam path is divided into a plurality of images, each of which contains different contributions to the image data acquired. Depending on the chosen embodiment of light field microscopy (see in more detail further below), the images may for example represent different viewing angles on the specimen. This makes it possible to reconstruct a three-dimensional structure of the specimen at any points of the image even after acquisition of the image data has been performed and completed.

### DESCRIPTION OF RELATED ART

Such reconstructions by means of various known deconvolution or unfolding algorithms require a complex and powerful computing technique and, with a high three-dimensional resolution of a resultant image of the specimen, are correspondingly time-consuming.

Three-dimensional processes are often to be observed and documented with a high spatial and temporal resolution with the help of light field microscopy. Such processes are usually studied in biological specimens that are either alive or the structures and constituents of which are sensitive to intense illumination.

However, with existing light field microscopes, it is difficult to determine the position of structures of interest relative to a current positioning of the region of focus of a detection objective, especially in the case of thick specimens. However, such a determination of the region of focus is of great interest, since both the axial and the lateral resolution decrease with increasing distance from the region of focus.

### SUMMARY OF THE INVENTION

The invention is based on the object of proposing a possible way in which, by using light field microscopy, regions and/or structures of interest of the specimen can already be localized before or during a high-resolution acquisition with regard to their relative position with respect to the region of focus, and consequently the effectiveness of the image acquisition is increased and the stress on the specimen is further reduced.

The invention includes but is not limited to the following embodiments:

1. A method, comprising:

providing an overview image of an object to be imaged in light field microscopy, in which

image data of at least one image of a region of the object are acquired by a detection optical unit and a detector; and

on the basis of the image data, computationally reconstructing a number of z planes (Zn) of the region under investigation,

wherein

a proportion of the image data acquired is used for the reconstruction; and/or

the number of z planes (Zn) to be reconstructed is reduced;

z sections (uhF, F, ohF) which lie around a focal plane (F) and above and below the focal plane (F) are defined in a z direction, which runs in a direction of an optical axis of the detection optical unit;

a channel is assigned to each of the z sections (Zn) and image data of structures of the object detected in respective z sections (Zn) are stored assigned to a respective channel; and

by a controller, control commands by which an output device is activated are generated, the structures being output according to the respectively assigned channels with different, but channel-specific graphical characteristics.

2. The method according to embodiment 1, wherein the reconstruction of the z planes (Zn) is performed by using a deconvolution approach for different angles of detection.

3. The method according to embodiment 1, wherein the reconstruction of the z planes (Zn) is performed by using a correlative z stack reconstruction algorithm.

4. The method according to embodiment 3, wherein an extent of a z stack comprising the z planes to be reconstructed or the reconstructed z planes (Zn) in the z direction is selected with reference to a usable focal length (DoF) of a microlens array in a detection beam path in an object space with a factor from a range of 0.1 to 20 times the focal length (DoF).

5. The method according to embodiment 4, wherein, when the overview image is created, a summation of intensities over a z section (uhF, F, ohF) is normalized to a number of summated z planes (Zn).

6. The method according to embodiment 1, wherein the reconstructed z planes (Zn) assigned to a z section (uhF, F, ohF) are in each case computationally processed to form a two-dimensional image.

7. The method according to embodiment 6, wherein the computational processing to form a two-dimensional image is performed by a maximum intensity projection.

8. The method according to embodiment 6, wherein the two-dimensional images of the z sections uhF, F, ohF are merged into a multi-channel image.

9. The method according to embodiment 1, wherein the structures assigned to a channel are in each case displayed with a color, geometry and/or pattern filling assigned to the channel, the manners of representation differing between the channels.

10. A light field microscope, comprising:

a detection beam path with a collecting optical unit for collecting a detection radiation coming from an object to be imaged,

a microlens array for generating a number of images, and

a two-dimensionally resolving detector, by which the number of images can be acquired,

as well as with an evaluation unit, which is configured

to computationally reconstruct a number of z planes (Zn) of the region under investigation on the basis of acquired image data of at least one image of a region of the object; and

to assign z sections (uhF, F, ohF) defined in the z direction around the focal plane (F) and above and below the focal plane (F) as well as structures of the object detected in the respective z sections (uhF, F, ohF) to each channel and optionally store them.

11. The light field microscope according to embodiment 10, wherein a controller, which is configured to generate control commands and to activate an output device by them, the structures being output according to the respectively assigned channels with different, but channel-specific graphical characteristics.

### BRIEF DESCRIPTION OF THE DRAWINGS

FIG. 1 shows a schematic representation of a specimen to be imaged in a lateral representation and with z sections chosen by way of example in the z direction (scenario A).

FIG. 2 shows a second schematic representation of a specimen to be imaged in a lateral representation and with z sections chosen by way of example in the z direction (scenario B).

FIG. 3 shows a third schematic representation of a specimen to be imaged in a lateral representation and with z sections chosen by way of example in the z direction (scenario C).

FIG. 4 shows a schematic representation of images of structures of the specimen acquired and each assigned to a z section and a channel in a lateral representation as well as a resultant overview image in a 2D view with visualization of the association of the respective structures with a z section.

FIG. 5 shows a schematic representation of a light field microscope according to the invention.

FIG. 6 shows a schematic flow diagram of a configuration of the method according to the invention.

### DETAILED DESCRIPTION OF THE INVENTION

The object is achieved by a method according to the independent embodiment and a device according to the alternative independent embodiment. Advantageous developments of the invention are the subject of the dependent embodiments.

The method is used for generating and providing an overview image of an object to be imaged (specimen), in which image data of at least one image of a region of the specimen are acquired by using a configuration of light field microscopy. The acquisition of the image data is performed at least by means of a detection optical unit and a detector in a detection beam path. The detector records measured values, which are evaluated and further processed as image data.

On the basis of the image data acquired, a number of z planes of the region under investigation are computationally reconstructed. Z planes are planes which in the detection direction (z direction) extend from a detection axis substantially orthogonally thereto (x-y planes), but in the detection direction lie one behind the other, i.e. in the direction of the detection axis. This understanding also includes planes that are inclined with respect to the detection axis and likewise lie one behind the other in the z direction (inclined).

A number of x-y planes are also referred to below as a z stack. During the reconstruction, positions, size, form and, if necessary, material and/or optical properties of structures of the specimen are determined on the basis of the measured values recorded. For example, structures may be defined cell constituents such as membranes, organelles or storage bodies. In addition, the cytosol and/or molecules and/or aggregations contained in it can be imaged. The z planes are reconstructed virtually in the image data representing the region under investigation of the specimen.

According to the invention, the method is characterized in that the reconstruction for the purpose of generating and providing the overview image preferably does not involve using all of the available image data, but instead a subset of the image data is used. A set of image data to be used can in this case be selected from the image data actually acquired, for example by only taking into consideration every second, third or nth data point (down-sampling). The image data to be used for the generation of the overview image are advantageously reduced by at least a factor 2 or more compared to the data set actually acquired. In addition or alternatively, the number of z planes to be reconstructed for the overview image can be reduced. Fewer z planes are advantageously reconstructed for an overview image than for the creation of a higher-resolution image.

Within the scope of the method according to the invention, z sections are defined with reference to the region under investigation in the z direction. At least one of the z sections contains the (nominal) focal plane, for example of lenses of a microlens array used (see below) or a number of cameras (detectors), or largely a region of focus extending in the z direction (see further below). Other z sections are defined above or below the focal plane or the region of focus. The number of z sections of the region under investigation can be chosen as required and be for example two, three, four, five or more. In a configuration which is advantageous, because it is computationally effective, three z sections are selected, as described in the following by way of example.

A channel is assigned to each of the selected z sections. This assignment determines in which form, for example with which color, form and/or pattern, image data of the relevant z section are to be displayed to a user. The assignments of acquired image data to a channel and to a specific z section are stored, so that a data record of the image data with associated metadata is created.

By means of a controller, control commands by means of which an output device is activated can then be generated, taking into account the data record and the metadata. The structures are output according to the respectively assigned channels with different, but channel-specific graphical characteristics. The metadata can also be used to optionally hide selected structures, i.e. not to display them graphically.

The method according to the invention can be applied to a single image or to a number of images. Advantageously, the method according to the invention is applied to a single image or multiple images which are recorded one after the other in time (sequentially). In this way it is possible for example for an overview image to be created or updated already during high-resolution image acquisition.

The invention essentially concerns generating and providing an overview image in a way that is fast and is possible with comparatively low computational effort. This is achieved by only computationally processing a selection of the acquired image data and/or choosing z planes with a thickness that still allows a sufficient axial resolution of the overview image, but keeps the number of z planes to be reconstructed to a minimum. In this way, suitable hardware, for example a GPU, can perform the reconstruction of the z planes with for example 5 Hz or more. This is not possible as fast when using all of the image data and/or when reconstructing a large number of z planes. In addition, the invention provides a user with essential support in correcting or setting the focal plane to structures of interest. Since the image data, in particular structures of the specimen recorded in the z sections, are displayed channel-specifically, it is also possible to immediately detect in a two-dimensional representation of the overview image whether structures of interest are located below, above or within the currently set focal plane. For this purpose, the image data of the different z sections are advantageously displayed differently, in particular in different colors, according to their channels. A setting of the focal plane relative to a structure of interest is thus considerably facilitated, since a relative position of the structure with respect to the current focal plane can be derived immediately as a result of the coding via the channel.

In the present description of the invention, image data are understood as meaning measured values that are recorded by detector elements of the detector or by multiple detectors and are passed on for further processing and evaluation. A focal plane or a region of focus or a usable focal length denotes a plane or a volume along the detection axis of the microlenses or the detectors or cameras over the extent of which the quality of the image data allows sufficiently sharp imaging (depth of field) and a high signal-to-noise ratio (SNR). To simplify matters, in the following reference is only made to the focal plane.

According to the invention, the image data are acquired according to one of the variants of light field microscopy. A common feature of the various variants considered below is that a microlens array with a plurality of (micro)lenses is arranged in the detection beam path. Each of the microlenses deflects a portion of the detection radiation, directs it onto a different region of the detector and forms and image of it there. The images are passed on to an evaluation and used as a basis for the reconstruction of at least one z plane.

Depending on where the microlens array is arranged in the detection beam path and how it is designed, essentially a distinction is made between the variants of light field microscopy briefly explained below. The invention can be used for all variants.

In a first variant, the microlens array (MLA) is arranged in an image plane (spatial domain) in which the detector would otherwise be located. The MLA has microlenses with a uniform focal length. The detector is arranged in the beam path at the distance of the focal length. The individual lenses of the MLA form an image of the incident detection radiation on the detector in their respective focus. If the origin of the detection radiation is not exactly in an object plane conjugated with the plane of the MLA, the effect of the microlenses causes lateral deflections of the detection radiation. The detector detects a pattern that varies depending on the position of the origin in the z direction (e.g.: Broxton, M. et al. 2013; Wave optics theory and 3-D deconvolution for the light field microscope; OPTICS EXPRESS 21: 25418 – 25439).

If, on the other hand, the MLA is placed in a plane conjugated with the entrance pupil of the detection objective (frequency domain; Fourier light field microscopy) and the detector is placed downstream of the MLA according to the focal length of the microlenses, a number of images are acquired by the detector, each reproducing the specimen from a slightly different angle of view (angle of detection). From the information on the lateral position of the images on the detector and their angle of detection, a part of the specimen can be reconstructed three-dimensionally (Guo C. et al. 2019; Fourier light-field microscopy; Optics Express 27: 25573 – 25594).

In order to reduce disadvantages of the aforementioned variants occurring, an MLA of which the microlenses are not arranged in a fixed pattern but randomly can be used in a pupil plane. In addition, it is possible that the microlenses have different focal lengths. Such a modification, known as a "diffuser-scope light field", is described for example by Liu et al. (2020) (Liu, F. L. et al. 2020; Fourier DiffuserScope: single-shot 3D Fourier light field microscopy with a diffuser; Optics Express 28: 28969 – 28986).

In order to perform the reconstruction of the z planes effectively within the scope of the invention, the image data to be used for this purpose are reduced compared to the image data actually acquired. Such a "down-sampling" before the 3D reconstruction is advantageously performed with a factor of two or higher. In addition, z planes that are two or more times thicker in the z direction than the z planes to be reconstructed for high-resolution imaging are reconstructed for the overview image ("rough sampling"). A reconstruction may be performed by using a deconvolution approach for different angles of detection (multiview deconvolution approach). For example, a Richardson-Lucy algorithm with Total Variation may be used for the reconstruction. Image data of structures outside a previously defined region of interest will either not be taken into consideration in the reconstruction or not be displayed. Such a reconstruction approach can be used for all variants of light field microscopy.

In other configurations of the method, a reconstruction of the z planes may be performed by using a correlative z stack reconstruction algorithm. For example, in the case of Fourier light field microscopy, the partial images obtained from different angles of detection can be correlated with a variable offset, where the factor depends on a z position of the origin of the acquired image data in the z direction and the angle of detection (angle of view of the relevant microlens) (so-called shift-and-multiply algorithm; e.g.: Sánchez-Ortiga, E. et al (2020): Optical Sectioning Microscopy Through Single-Shot Lightfield Protocol, IEEE Access, 8: 14944 – 14952).

The extent both of the z planes to be reconstructed and of the z sections comprising one or more z planes in the z direction can be chosen depending on the properties of the illumination optical unit used, the detection optical unit, the properties of the specimen, the illumination and/or detection radiation as well as the question to be answered by means of the image acquisition.

In one configuration of the method according to the invention, the extent of a stack to be reconstructed or a reconstructed stack of a number of z planes (z stack) in the z direction is selected with reference to a usable focal length of the (micro)lenses of the microlens array in the object space with a factor from a range of 0.1 to 20 times the usable focal length. This achieves the effect that the z stack is in relation to the actual design and optical properties of the detection optical unit.

As already described above, a z section may comprise multiple z planes. The reconstructed z planes assigned to a z section can in each case be computationally processed to form a two-dimensional image. To form a two-dimensional image of the relevant z section, the calculated intensities of the z planes can be summated and incorporated into the two-dimensional image. The computational processing to form a two-dimensional image may for example be performed by means of a maximum intensity projection. In this case, intensities detected in a known manner at locations lying one behind the other in one direction, for example in the z direction, and projected into a virtual two-dimensional plane are summated.

In another configuration of the method according to the invention, the number of summated z planes can be taken into consideration, in particular normalized, by dividing the sums calculated over a z section for example by the number of underlying z planes.

The two-dimensional images of the z sections obtained can be merged into a multi-channel image. Despite a two-dimensional representation, the metadata assigned to the image data allow information on a three-dimensional positioning of recorded structures to be visualized, for example by graphically displaying them differently for each channel, i.e. depending on their presence in one of the z sections.

In addition to the method, the object is achieved by a light field microscope, which comprises in a detection beam path with a collecting optical unit for collecting a detection radiation coming from an object to be imaged, a microlens array for generating a number of images and a two-dimensionally resolving detector, by means of which the number of images can be acquired, in particular simultaneously. In addition, there is an evaluation unit, which takes the form of a computer, a logical gate such as an FPGA (field programmable gate array) or a microcontroller. The evaluation unit is configured to computationally reconstruct a number of z planes of the region under investigation on the basis of acquired image data of at least one image of a region of the object. The number of z planes to be reconstructed and/or the amount of image data to be used for the reconstruction is reduced as described above in order to allow a largely instantaneous generation of an overview image with progressively or continuously acquired image data of the specimen. Z sections are defined in the z direction around the focal plane and above and below the focal plane. Structures of the object detected in the respective z sections on the basis of their image data are assigned in each case to a channel and optionally stored. The evaluation unit may for this purpose be connected to a data memory, for example a RAM, SSD ("solid state device") or a hard disk in a suitable connection for the exchange of data.

A microscope according to the invention may also have a controller which is configured to generate control commands and to activate an output device by means of them. The structures are output according to the respectively assigned channels with different, but channel-specific graphical characteristics. A controller may be realized for example by a computer, a microcontroller or an FPGA.

The invention allows an overview image to be generated in an advantageous manner with sufficient quality and a high repetition rate. Therefore, the invention is suitable for use during continuous investigation of a specimen using light field microscopy. For a user, it is of great advantage that recorded structures are displayed in terms of their position relative to a current focal plane, so that a first or renewed focusing on the relevant structures can be performed specifically and without lengthy movements back and forth in search of them.

Resultant overview images, for example multi-channel images, created by means of the method according to the invention can be advantageously used to realign the specimen in the z direction if necessary. It is also possible to use the data underlying the overview image as a basis for automatically aligning and positioning the specimen in the z direction, optionally in the x and/or y direction, or automatically tracking the specimen with respect to the focus.

The invention is explained in more detail with reference to exemplary embodiments and figures.

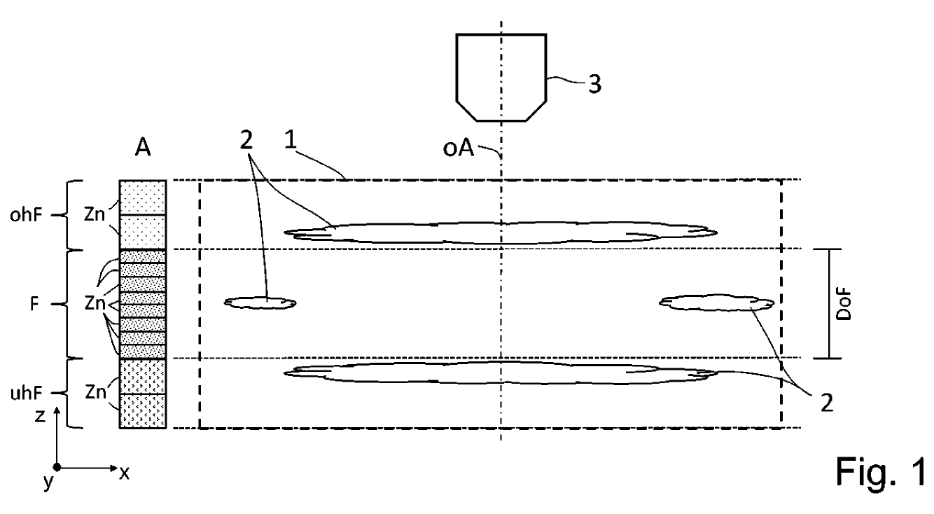

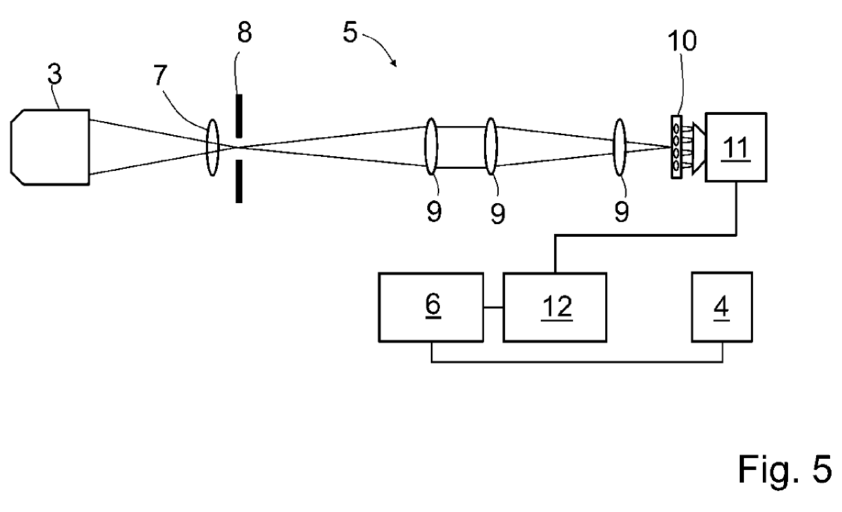

The basic idea of the invention can be explained by reference to FIG. 1. A specimen 1 shown only schematically is arranged in a specimen chamber, for example of a microscope 5 (see FIG. 5), in particular of a light field microscope 5, and is at least partially located in a potential detection range of a detection objective 3. Present in the specimen 1 are various structures 2, which are to be displayed when detection radiation coming from the specimen 1 or from the structures 2 is picked up and evaluated. The relative positions of the technical elements and specimen constituents involved are specified below using the axes of a Cartesian coordinate system. The drawing plane is in a plane spanned by the axes x and z, while the y axis is perpendicular to the drawing plane.

Depending on the design and interaction with other optical elements of a detection beam path (see FIG. 5) in the direction of an optical axis of the detection objective 3, the detection objective 3 has a depth of field DoF. The vertical extent of the depth of field (DoF), which is directed in the direction of the z axis (z direction), allows image data of the specimen 1 to be acquired or its structures 2 to be recorded with a predetermined quality and images to be created with a desired sharpness.

In the course of the invention, for example, three z sections are defined along the z direction. In the example, a z section F is given by the extent of the depth of field DoF and represents a region of focus or a focal plane F (see above). Another z section is adjacent to the focal plane F above and is referred to as the z section ohF, while the third z section is adjacent to the focal plane F below and is referred to as the z section uhF.

Within the z sections uhF, F, ohF, z planes Zn extending in the direction of the x and y axes, which are arranged one on top of the other in the z direction, are defined. The z planes Zn are slices with a respective extent in the z direction (thickness) of which the acquired image data are to be computationally processed (reconstructed) to form a two-dimensional image in each case. In order within the meaning of the invention to allow a fast, as far as possible instantaneous, generation of an overview image, the number of the respective z planes Zn per z section uhF, F, ohF may be kept low. In addition, their number may be adapted to an axial resolution sufficient for an overview image per z section uhF, F, ohF.

In the example shown in FIG. 1, two z planes Zn are defined in each case in the z sections above and below the focal plane F, i.e. in the z sections uhF and ohF. In the focal plane F, which corresponds to the depth of field DoF, on the other hand, eight z planes Zn are defined, each having a smaller thickness than the z planes Zn of the z sections uhF and ohF. In the z section F, a higher axial resolution can thus be achieved than in the z sections uhF and ohF.

The structures 2 of the specimen 1 shown in the example can in each case be uniquely assigned to one each of the z sections uhF, F and ohF. In the computational reconstruction of the individual z planes Zn, the image data of the structures 2 can be assigned their respective association with a particular z plane Zn and stored for later consideration. If structures 2 extend over multiple z sections uhF, F, ohF, then the relevant components of the structures 2 can be assigned to different channels and graphically displayed differently.

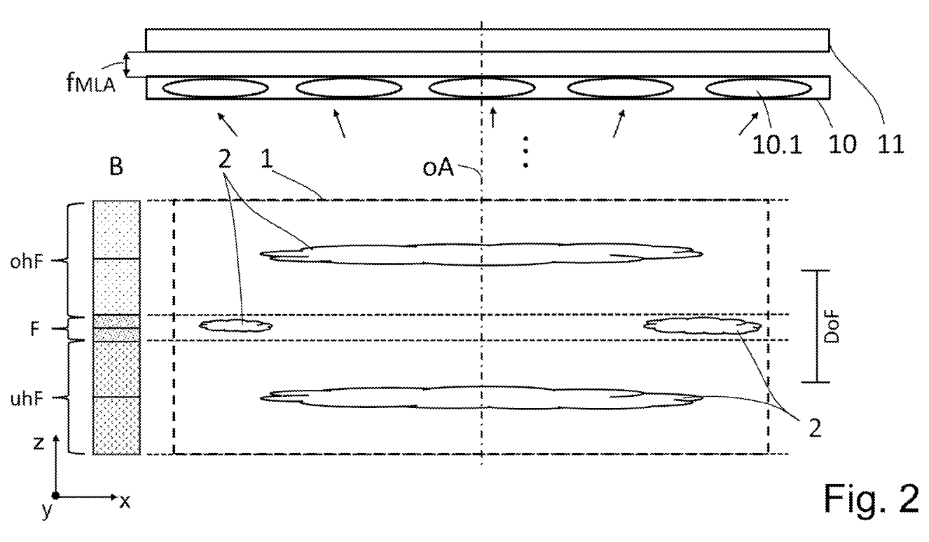

In another example of a possible configuration of the invention (FIG. 2), the extent of the focal plane F in the z direction is chosen to be less than the depth of field DoF, while the thicknesses of the z planes Zn of the two adjacent z sections uhF and ohF are greater than in the previous example (see FIG. 1).

FIG. 2 shows the last two components of the detection beam path in the form of a microlens array 10 with a number of microlenses 10.1. Arranged at a focal distance fMLA of the microlenses 10.1 of the microlens array 10 is a detector 11, by means of which optical information transmitted from the individual microlenses 10.1 can be recorded in a spatially resolved form.

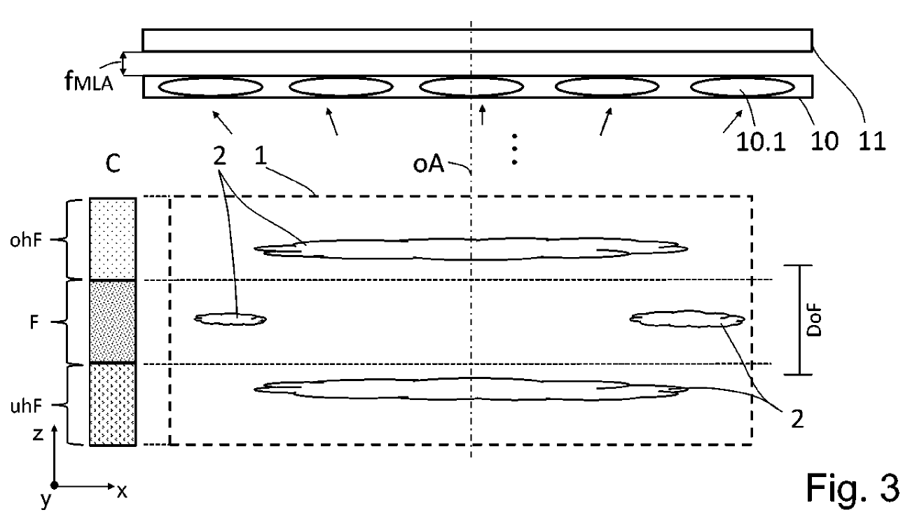

In another configuration of the invention, the z sections uhF, F and ohF can be chosen to be equally thick and for example also to have the same numbers of z planes Zn. In FIG. 3, only one z plane Zn is reconstructed in each z section uhF, F and ohF.

The choice of the extents of the z sections uhF, F and ohF in the z direction as well as their respective number and thickness of z planes Zn can be chosen depending on the relevant specimen 1, the optical properties of the detection system used, for example the microscope 5, and/or the desired frame rate and resolution of the overview image to be generated.

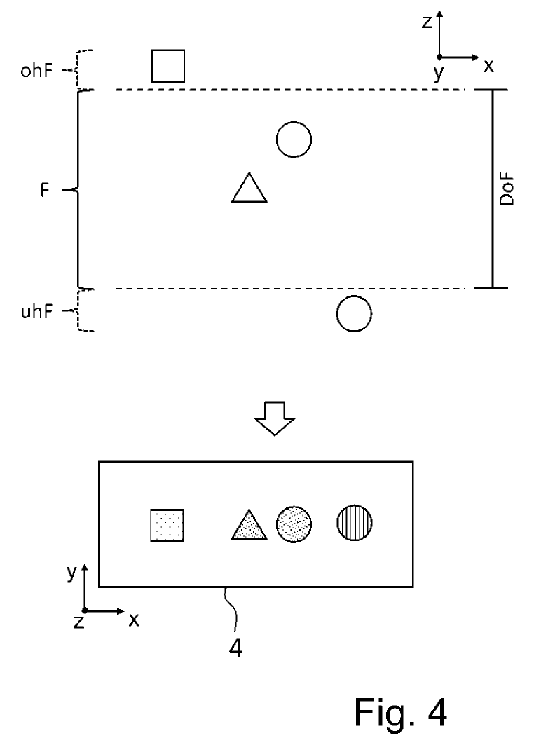

After the image data of the specimen 1 have been acquired and stored together with the information of the associated z sections uhF, F and ohF, a two-dimensional overview image can be generated from this information. The principle is shown in FIG. 4.

Depending on their association with one of the z sections uhF, F, ohF, the structures 2 are assigned for example a graphical feature (channel), by which the association of the structures 2 with the z sections uhF, F, ohF is visually recognizable. In the example of FIG. 4, different filling patterns have been assigned to the structures 2. In the upper partial image of FIG. 4 it can be seen that one structure 2 is in the z section uhF, two in the z section F and one structure 2 in the z section ohF. The relative positions of the structures 2 in relation to one another in the direction of the z axis and in the direction of the x axis can be seen.

If the z planes Zn are merged into a two-dimensional image that extends in the sense of an overview image in an x-y plane spanned by the x axis and the y axis (lower partial image), the information about their position in the z direction is lost. However, it can be seen from the overview image that the structures 2 are all at the same position in the y direction, while they are separate from one another along the x axis. In other examples, some or all of the structures 2 could also have different positions in the y direction. The overview image can be displayed to a user on an output device 4 or a display 4.

The positions of the structures 2 in the direction of the z axis, which can no longer be visually deduced directly, can be derived in the overview image with the aid of the assigned filling patterns. Thus, the structure 2 in the z section uhF is indicated by a line filling, the two in the z section F by a dense dot filling and the structure 2 in the z section ohF by a low-density dot pattern. In other configurations, the structures 2 may alternatively or additionally be individually shown in different colors and/or with other forms or hidden.

Starting from the overview screen, a user can recognize which of the structures 2 currently lie in the focal plane F or below or above it. If, for example, the structure shown on the far left in the overview image in FIG. 4 is to be placed 2 in the focal plane F, the focal plane F must be displaced upward. There is obviously no need to search for this structure 2 below the focal plane F. In this way, the time required for focusing the structure 2 previously located above the focal plane F is shortened considerably, since the z section uhF below the focal plane F does not have to be searched.

Since, as briefly described above, a position of the structure 2 in the x and y direction can also be concluded from the overview image, a shift of the focal plane F can be accompanied at the same time by a displacement of the image region in the x direction and/or in the y direction.

A general structure of a microscope 5 according to the invention, in particular a light field microscope 5, is shown highly schematically in FIG. 5. A detection radiation collected with the detection objective 3 is guided along a detection beam path by means of optical elements such as a tube lens 7, a field stop 8 and other optical lenses 9. Optionally, the specified optical lenses 9 also represent corresponding combinations of optical elements (lens systems). The detection radiation is directed onto the microlens array 10, which is arranged in a pupil of the detection beam path. An image of the pupil plane of the microscope 5, in particular a pupil plane (back focal plane) of the objective 3, is projected into the plane of the microlens array 8 via the lens system 7, 9. In this case, the lens 9 in front of the microlens array 10 acts as a Fourier lens, i.e. it causes a Fourier transformation of the detection radiation.

A two-dimensional detector 11 is arranged downstream of the microlens array 10, at the focal length fMLA thereof. By the action of the microlenses 10.1 (shown in an indicative manner) of the microlens array 10, an image of the detection radiation is projected onto the detector 11 in a number of spatially separate partial images. Each of the partial images represents an image of the specimen 1 from a different angle of detection (also see FIG. 1).

In other configurations of the invention, the microlens array 10 may also be arranged in an intermediate image plane. In addition, it is possible that the microlenses 10.1 of the microlens array 10 have different focal lengths and/or are arranged irregularly or randomly over the surface area of the microlens array 10.

The image data acquired by the detector 11 are transferred to an evaluation unit 12 in the form of for example a computer or an FPGA. The evaluation unit 12 is configured in such a way that the evaluation of the acquired image data takes place takes into consideration location information, angle information and/or intensity values. In particular, a number of z planes Zn of the region under investigation are reconstructed computationally on the basis of acquired image data of at least one image of a region of the specimen 1. In addition to the reconstruction of z planes Zn and the generation of a data record for a (updated) overview image, the evaluation unit 12 may also be configured for the (additional) reconstruction of z planes Zn and the generation of higher-resolution or high-resolution images. These may also be generated and provided as a three-dimensional image data record.

On the basis of the computationally determined data of the reconstructed z planes Zn as well as the optionally associated graphical features of recorded structures 2 in dependence on an assignment to the relevant z sections uhF, F, ohF, control commands are generated by means of a controller 13 and transmitted to an output device 6, in particular a display 6, for example to a screen or display. In this way, the output device 6 is activated and for example displays an overview image described above to a user.

The controller 13 may optionally be connected to other elements of the microscope 5 and activate them. For example, a specimen stage, focusing units, an illumination unit (all not shown), the field stop 8 and/or the detector 11 may be activated and adjusted to meet current requirements for the acquisition of image data.

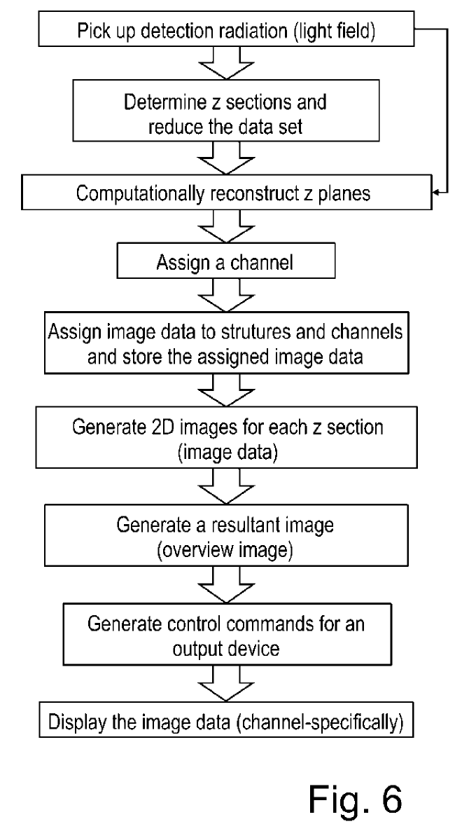

The method according to the invention is described below with reference to a flow diagram (FIG. 6). In the first steps, detection radiation is picked up by means of a suitable device, in particular by means of a light field microscope 5. The technical and optical structure of the device as well as the recording and computational processing of the measured values obtained is performed according to the concept of the light field or light field microscopy. After the detection radiation has been picked up, or already before this method step, the number and thickness of the z planes Zn to be reconstructed, and thus the extent of the z sections uhF, F, ohF in the z direction, are determined. The determination may take into account measured values recorded for the detection radiation or, if necessary, be modified. If the method is carried out multiple times, the step of determining the z sections and z planes does not need to be repeated each time, but can be skipped once they have been determined.

The z planes Zn of the individual z sections uhF, F, ohF are computationally reconstructed on the basis of the measured values recorded, for example by using known reconstruction algorithms. A channel is assigned to each of the individual z planes Zn or the structures 2 of the specimen 1 respectively contained there. This specifies how the structures 2 are to be graphically displayed in the course of the method. The image data of the reconstructed z planes Zn are stored in such a way that they are repeatedly retrievable and assigned to the respective z sections and channels.

In alternative methods, image data may also only be acquired and evaluated in one z section, for example the region of focus F. The selection of two or four z sections is also possible.

In a next step, the image data of each z section are computationally processed to form a two-dimensional image. The 2D image extends in the x-y plane. The relative positions of the structures 2 in relation to one another are advantageously preserved. The 2D images of the z sections are then merged into a resultant overview image. This also extends in the x-y plane. The individual structures 2 of the z sections are in each case displayed differently according to their channel assignment. The positionings of the structures 2 in the direction of the x and y axes determined during reconstruction can be taken from the overview image. The position in the z direction is coded by the channel-specific graphic design of the structures 2. The steps of reconstruction and creation of 2D and 3D images are performed with the evaluation unit 12.

In order to not only present the overview image as a data record, but also to be able to display it to a user, 13 control commands are generated by means of the controller and transmitted to the output device 6. The control commands are used to activate the output device 6 and result in a channel-specific display of the image data.

The method according to the invention can be carried out in other configurations with feedback loops. For example, an input by the user may lead to a modification of the control commands of the controller 13. Similarly, a selection by the user may result in a modified selection of parameters when determining the z sections and z planes to be recorded, reconstructed, and merged for the overview image (for example: number of z planes; thickness of z planes and/or z sections in z direction; characteristics of the channels).

### Reference signs

1 Region under investigation; specimen

2 Structure

3 Objective

4 Display

5 Light field microscope

6 Controller

7 Tube lens

8 Field stop

9 Optical lens

10 Microlens array

10.1 Microlens; lens (of the microlens array 10)

11 Detector

12 Evaluation unit

A First scenario

B Second scenario

C Third scenario

DoF Depth of field

F Focal plane or middle z region

fMLA Focal length of the microlens array 10

ohF z section above the focal plane F or above the middle z region

uhF z section below the focal plane F or below the middle z region

Zn z plane(s)

1. A method, comprising:
providing an overview image of an object to be imaged in light field microscopy, in which
image data of at least one image of a region of the object are acquired by a detection optical unit and a detector; and
on the basis of the image data, computationally reconstructing a number of z planes (Zn) of the region under investigation,
wherein
a proportion of the image data acquired is used for the reconstruction; and/or
the number of z planes (Zn) to be reconstructed is reduced;
z sections (uhF, F, ohF) which lie around a focal plane (F) and above and below the focal plane (F) are defined in a z direction, which runs in a direction of an optical axis of the detection optical unit;
a channel is assigned to each of the z sections (Zn) and image data of structures of the object detected in respective z sections (Zn) are stored assigned to a respective channel; and
by a controller, control commands by which an output device is activated are generated, the structures being output according to the respectively assigned channels with different, but channel-specific graphical characteristics.

2. The method according to claim 1, wherein the reconstruction of the z planes (Zn) is performed by using a deconvolution approach for different angles of detection.

3. The method according to claim 1, wherein the reconstruction of the z planes (Zn) is performed by using a correlative z stack reconstruction algorithm.

4. The method according to claim 3, wherein an extent of a z stack comprising the z planes to be reconstructed or the reconstructed z planes (Zn) in the z direction is selected with reference to a usable focal length (DoF) of a microlens array in a detection beam path in an object space with a factor from a range of 0.1 to 20 times the focal length (DoF).

5. The method according to claim 4, wherein, when the overview image is created, a summation of intensities over a z section (uhF, F, ohF) is normalized to a number of summated z planes (Zn).

6. The method according to claim 1, wherein the reconstructed z planes (Zn) assigned to a z section (uhF, F, ohF) are in each case computationally processed to form a two-dimensional image.

7. The method according to claim 6, wherein the computational processing to form a two-dimensional image is performed by a maximum intensity projection.

8. The method according to claim 6, wherein the two-dimensional images of the z sections uhF, F, ohF are merged into a multi-channel image.

9. The method according to claim 1, wherein the structures assigned to a channel are in each case displayed with a color, geometry and/or pattern filling assigned to the channel, the manners of representation differing between the channels.

10. A light field microscope, comprising:
a detection beam path with a collecting optical unit for collecting a detection radiation coming from an object to be imaged,
a microlens array for generating a number of images, and
a two-dimensionally resolving detector, by which the number of images can be acquired,
as well as with an evaluation unit, which is configured
to computationally reconstruct a number of z planes (Zn) of the region under investigation on the basis of acquired image data of at least one image of a region of the object; and
to assign z sections (uhF, F, ohF) defined in the z direction around the focal plane (F) and above and below the focal plane (F) as well as structures of the object detected in the respective z sections (uhF, F, ohF) to each channel and optionally store them.

11. The light field microscope according to claim 10, wherein a controller, which is configured to generate control commands and to activate an output device by them, the structures being output according to the respectively assigned channels with different, but channel-specific graphical characteristics.
